(19) United States
(12) Patent Application Publication
(10) Pub. No.: US 2019/0311352 A1
(43) Pub. Date: Oct. 10, 2019

(54) METHOD AND SYSTEM FOR CONDUCTING TRANSACTIONS ON CRYPTOCURRENCIES WITH UNDERLYING VALUE SUPPORTED BY INTELLECTUAL PROPERTIES AND INTANGIBLE ASSETS

(71) Applicant: Aeneas Technology Limited, Hong Kong (HK)

(72) Inventors: Darren Wang Yip Lui, Hong Kong (HK); Chung Yuen Ian Huen, Hong Kong (HK)

(21) Appl. No.: 16/380,997

(22) Filed: Apr. 10, 2019

Related U.S. Application Data
(60) Provisional application No. 62/655,246, filed on Apr. 10, 2018.

(51) Int. Cl. G06Q 20/36; G06Q 20/06; G06Q 30/02

(52) U.S. Cl. CPC G06Q 20/3678; G06Q 30/0202; G06Q 20/065

(57) ABSTRACT

A method for issuing and maintaining a cryptocurrency backed by backing assets comprising intellectual properties and intangible assets, the method comprising: receiving the ICO data, wherein the ICO data includes the identity of a fund-raising entity, fund-raising goal minimum and maximum, and subscription criteria; receiving backing asset data comprising identification, cost, income, and ownership data; verifying the backing assets; valuating the backing assets' economic value with input variable parameter values comprising R&D cost, past royalty received, future royalty expected, allotted operating income, and future income, projected market size and revenue generated, the backing assets' registration approval probability, the backing assets' regulatory approval probability and timing, commercialization probability, and precedent data of comparable assets; binding the backing asset's economic ownership to the cryptocurrency by effectuating an execution of a smart contract by the fund-raising entity vesting the backing asset's economic ownership in a holding entity; and executing a token pricing function.

### CROSS-REFERENCE WITH RELATED APPLICATIONS

This application claims priority to the U.S. Provisional Patent Application No. 62/655,246 filed Apr. 10, 2018; the disclosure of which is incorporated herein by reference in its entirety.

### FIELD OF THE INVENTION

The present invention relates generally to electronic processing systems, particularly, electronic databases and data processing apparatuses, and methods for conducting transactions on digital currencies, including virtual currencies, cryptocurrencies, and other types of non-fiat financial instruments. Particularly, the present invention relates to cryptocurrencies that are based on the values of intellectual properties and other intangible assets.

### BACKGROUND

A digital currency is a medium of exchange that is electronically created and stored. A cryptocurrency, such as Bitcoin, is one particular embodiment of digital currency that uses cryptography for security and prevention of counterfeiting and/or fraud. Cryptocurrency can also be characterized as being implemented in a distributed manner across a network of computing devices that maintains a ledger, which is used to record all transactions conducted using the cryptocurrency by all users chronologically. Transactions recorded may include transfers of ownerships/titles in each unit (a.k.a. “coin”), conversions from a fiat-currency or other virtual currencies to the cryptocurrency, and issuance of new units of the cryptocurrency. The term “blockchain” is used to describe such distributed ledger maintenance and management method and system. The integrity and the chronological order of the cryptocurrency transaction recording in blockchain are enforced with cryptography.

The term “mining” refers to the process and actions taken on the data pertaining to a waiting cryptocurrency transaction to confirm the transaction by including it in a block of the blockchain and be verified by the cryptocurrency system. The process of mining enforces a chronological order in the blockchain, protects the neutrality of the cryptocurrency network, and allows different computing devices to agree on the state of the cryptocurrency system. Specific mining rules of the cryptocurrency system may be setup to prevent the modification of existing blocks that would invalidate all following blocks; and to prevent any individual or computing device from easily adding new blocks consecutively in the blockchain without verification by the system. This way, no individuals can control what is included in the blockchain or replace parts of the blockchain to roll back their own expenditure or transfer. The term “miner” refers to a computing device or entity that participates in the mining activity by attempting to cryptographically perform the computational task required to generate a new block in the blockchain.

A financial transaction, such as a change of ownership/title of certain unit of the cryptocurrency is facilitated by data exchanges between two or more computing devices configured to send, receive, store, and manage the cryptocurrency data, including information of ownerships of cryptocurrency units. A computing device that stores information of ownership of cryptocurrency units is called a “cryptocurrency wallet” or “node”. When the financial transaction is initiated, the data pertaining to the transaction is propagated through the network of cryptocurrency wallets and eventually included in a block of the blockchain.

Another aspect of cryptocurrency is initial coin offering (ICO). In an ICO, a unit quantity of a crowdfunded cryptocurrency is pre-allocated to investors in the form of “tokens”, in exchange for legal tender, fiat currencies, or other virtual currencies. These tokens supposedly become the functional units of a new or an existing cryptocurrency representing certain value if and/or when the ICO's funding goal is met. ICOs provide a means by which the coin offeror can avoid the costs of regulatory compliance and intermediaries, such as venture capitalists, banks, and stock exchanges. Currently, few countries are officially regulating ICO activities and some other countries outlaw ICOs altogether. Nonetheless, ICOs are increasingly popular with startup companies and entrepreneurs looking to crowdfund their ventures. Other than ICOs, there are other ways for the fund-raising entities to sell tokens, including but not limited to, selling in private sale and through cryptocurrency exchanges (together with ICOs, hereinafter collectively referred to as “Token Sale”). Private sales and distributions through cryptocurrency exchanges, unlike ICO, usually do not have funding goal minimums and maximums.

For an asset-backed cryptocurrency, since the crowdfunded cryptocurrency tokens are inherently tied to the value of the backing asset, be it a tangible physical asset such as a set amount of gold, certain company's shares, or the equity in a project, the value of the crowdfunded cryptocurrency tokens is supposedly closely related to the asset value. Thus, one issue with asset-backed cryptocurrency is how to secure and valuate an asset used in backing the cryptocurrency during Token Sale and thereafter. Another issue with cryptocurrency is how to systematically set the prices and exchange rates with fiat currencies and with other cryptocurrencies in relation to their underlying assets' changing values over time. Still another issue is how to execute a redemption of the asset-backed cryptocurrency with its underlying assets from time to time.

### SUMMARY OF THE INVENTION

In accordance to one aspect of the present invention, a cryptocurrency infrastructure is provided for an asset-backed cryptocurrency, wherein the backing asset comprises one or more intellectual properties and intangible properties of one or more types. The intellectual properties and intangible properties may include, but not limited to, registered patents, pending patent applications, registered and unregistered trademarks, registered and unregistered industrial design and design patents, copyrights, trade secrets, commercialization rights, know-hows, and discoveries, as well as licenses to, liens on, options to purchase/sell, collateralized security interests in any one of the above, portion and/or combination thereof. In particular, trade secrets, know-hows, and discoveries may include unpublished and/or exclusive rights on (or possibility of exclusive and/or restrictive distribution and use) pharmaceutical chemicals, genetic materials, medical devices, treatment procedures, and indications thereof.

In accordance to another aspect of the present invention, the cryptocurrency infrastructure comprises a cryptocurrency platform for providing the functionalities including: hosting one or more Token Sales for one or more fund-raising entities and subscribers of token holder, which may include verifying the legal and economic titles in the backing assets sold in the Token Sales; determining the economic values of backing assets; binding the economic ownerships of the backing assets to the cryptocurrency of choice of the Token Sale by securing and holding (e.g. by smart contracts or legal instruments including fixed and floating charges) the economic ownerships of the backing assets in a holding entity; providing pricing of tokens; executing the issuance and distribution of tokens; interacting with the blockchain nodes, wallets, and miners 105 of the cryptocurrency; operating through one or more proprietary or third-party exchanges 106 for conducting exchanges of units of one or more cryptocurrencies with units other cryptocurrencies, fiat currencies, and redemption of the cryptocurrency units with their underlying backing assets. A fund-raising entity in a Token Sale may be a natural person, legal company, partnership, organization, non-governmental organization (NGO), academic institute, or governmental agency. The Token Sales may issue tokens of one or more existing cryptocurrencies (e.g. Bitcoin, Bitcoin Cash, Dash, Ethereum, ERC20 tokens, Litecoin, etc.), or newly created ones (e.g. Altcoins).

In accordance to another aspect of the present invention, the cryptocurrency infrastructure is configured to assess the economic value of the backing assets based on one or more valuation methods including, but not limited to, cost-based valuation method, income-based valuation method, and market-based valuation method with a number of input variable parameters. Under the cost-based valuation method, variable parameter values may include costs on research and development in generating the backing asset, costs on procuring and maintaining the backing asset. Under the income-based valuation method, the variable parameter values may include past license royalty (monetary amount and duration) received, future license royalty (monetary amount and duration) expected, allotted operating income based on the backing asset received, and future operating income based on the backing asset expected. Under the market-based valuation method, the variable parameter values may include existing or agreed royalties and licensing income (if applicable), projected market size and revenue generated from the use of the backing asset (e.g. a pharmaceutical product), IP registration approval probability and timing, regulatory approval (e.g. U.S. Food and Drug Administration approval) probability and timing, product commercialization probability and timing, current and historical market information and precedent information of comparable assets.

### BRIEF DESCRIPTION OF THE DRAWINGS

Embodiments of the invention are described in more detail hereinafter with reference to the drawings, in which:

FIG. 1 depicts a block diagram of the logical interactions and dataflow of a cryptocurrency infrastructure comprising a cryptocurrency platform and components of an electronic and data infrastructure for a cryptocurrency backed by intellectual properties and intangible assets in accordance to one embodiment of the present invention;

FIG. 2 depicts a system schematic diagram of the cryptocurrency infrastructure in accordance to one embodiment of the present invention; and

FIG. 3 depicts a process flow diagram of the cryptocurrency infrastructure in accordance to one embodiment of the present invention.

### DESCRIPTION OF THE INVENTION

In the following description, methods and systems for conducting transactions on cryptocurrencies with underlying value supported by intellectual properties and intangible assets and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

In accordance to one aspect of the present invention, a cryptocurrency infrastructure is provided for an asset-backed cryptocurrency, wherein the backing asset comprises one or more intellectual properties and intangible properties of one or more types. The intellectual properties and intangible properties may include, but not limited to, registered patents, pending patent applications, registered and unregistered trademarks, registered and unregistered industrial design and design patents, copyrights, trade secrets, commercialization rights, know-hows, and discoveries, as well as licenses to, liens on, options to purchase/sell, collateralized security interests in any one of the above, portion and/or combination thereof. In particular, trade secrets, know-hows, and discoveries may include unpublished and/or exclusive rights on (or possibility of exclusive and/or restrictive distribution and use) pharmaceutical chemicals, genetic materials, medical devices, treatment procedures, and indications thereof.

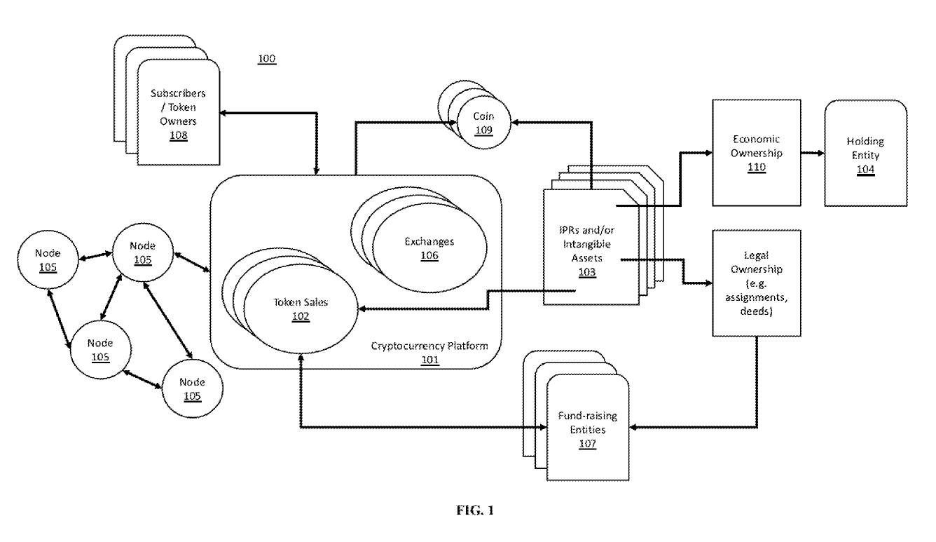

Referring to FIG. 1. In accordance to another aspect of the present invention, the cryptocurrency infrastructure comprises a cryptocurrency platform 101 for providing the functionalities including: hosting one or more Token Sales 102 for one or more fund-raising entities 107 and subscribers of token holder 108, which may include verifying the legal and economic titles in the backing assets 103 sold in the Token Sales 102; determining the economic values of backing assets 103; binding the economic ownerships 110 of the backing assets 103 to the cryptocurrency 109 of choice of the Token Sales 102 by securing and holding (e.g. by smart contracts or legal instruments including fixed and floating charges) the economic ownerships of the backing assets 103 in a holding entity 104; providing pricing of tokens; executing the issuance and distribution of tokens; interacting with the blockchain nodes, wallets, and miners 105 of the cryptocurrency; operating through one or more proprietary or third party exchanges 106 for conducting exchanges of units of one or more cryptocurrencies with units other cryptocurrencies, fiat currencies, and redemption of the cryptocurrency units with their underlying backing assets. A fund-raising entity 107 in a Token Sale 102 may be a natural person, legal company, partnership, organization, non-governmental organization (NGO), academic institute, or governmental agency. The Token Sales 102 may issue tokens of one or more existing cryptocurrencies (e.g. Bitcoin, Bitcoin Cash, Dash, Ethereum, ERC20 tokens, Litecoin, etc.), or newly created ones (e.g. Altcoins).

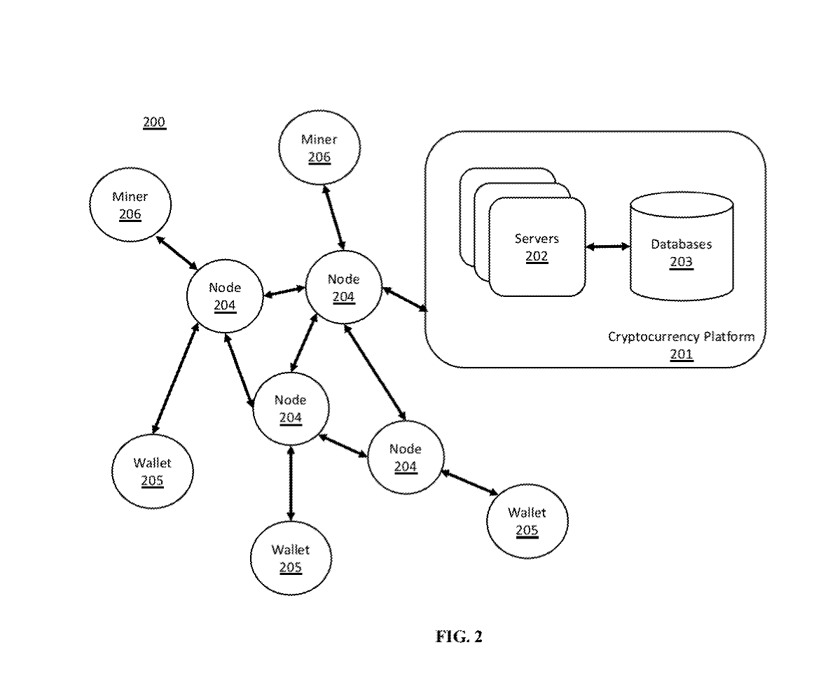

Referring to FIG. 2. In one embodiment, the platform 201 comprises one or more computing devices and servers 202, and one or more databases 203 configured to create and maintain a data schema specific to the operations of the cryptocurrencies including the corresponding Token Sales and the exchanges. The cryptocurrency infrastructure having the platform 201 further comprises a plurality of node computing devices and servers 204 that serve as blockchain full nodes and light nodes for maintaining the one or more blockchains; a plurality of wallet computing devices 205 that provide cryptocurrency wallets to token holders; and one or more miner computing devices and servers 206 that validate transactions of the cryptocurrency. In one embodiment, the computing devices and servers 202 are further configured to render a graphical user interface (GUI) for receiving user input on the event data and the backing asset data; and to generate and manage data exchanges with public information systems.

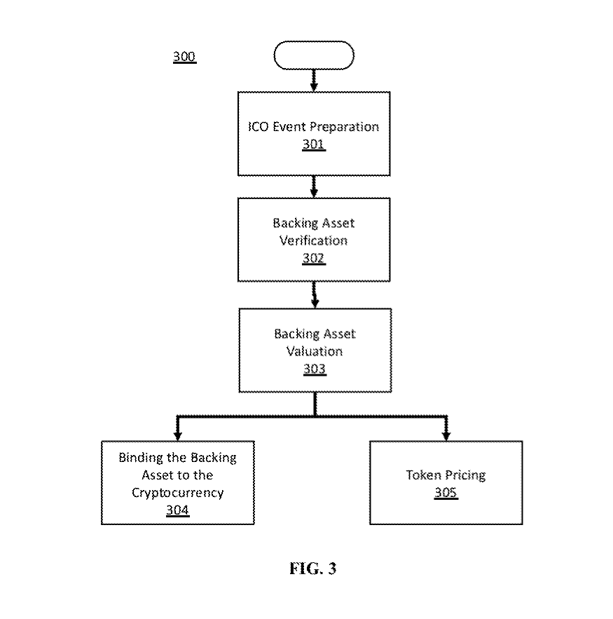

Referring to FIG. 3. In one embodiment, the platform 201 is configured to execute an Token Sale process 300 comprising a preparation for a Token Sale event 301; a verification of one or more backing assets sold in the Token Sale 302; a valuation of the economic value of the backing assets 303; a binding of the backing assets to the cryptocurrency of choice of the Token Sale 304; and a token pricing function 305.

In accordance to one embodiment, the preparation of an ICO event 301 comprises receiving, verifying, generating, and preserving the event data and the backing asset data in the databases, wherein the event data includes at least the identity information of a fund-raising entity, fund-raising goal minimum and maximum monetary amounts, subscription criteria such as minimum and maximum number of tokens subscribe-able by each subscriber, and offer start time and end time. The backing asset data includes, but not limited to, the backing asset's identification, description, type, term (e.g. remaining economic life), procurement costs, expected future maintenance costs, income generated, expected future income, projected future income, title documents, ownership statements and/or agreements.

In accordance to one embodiment, the verification of the backing assets offered for the Token Sale 302 comprises retrieving the title documents, ownership statements and/or agreements from the backing asset data preserved; searching and retrieving relevant records queried and retrieved from public information systems including, but not limited to, official recordation registries and judicial court record repositories; and comparing title documents, ownership statements and/or agreements retrieved from the backing asset data and the records queried and retrieved from third party information sources and/or public information systems.

In accordance to one embodiment, the valuation of the economic value of the backing assets 303 is based on one or more valuation methods including, but not limited to, cost-based valuation method, income-based valuation method, and market-based valuation method with a number of input variable parameters. Under the cost-based valuation method, variable parameter values including, but not limited to, costs on research and development in generating the backing asset, costs on procuring and maintaining the backing asset are received by the computing devices and servers 202, which can be via user input. Under the income-based valuation method, the variable parameter values including, but not limited to, past license royalty (monetary amount and duration) received, future license royalty (monetary amount and duration) expected, allotted operating income based on the backing asset received, and future operating income based on the backing asset expected are received by the computing devices and servers 202, which can be via user input. Under the market-based valuation method, the variable parameter values including, but not limited to, existing or agreed royalties and licensing income (if applicable), projected market size and revenue generated from the use of the backing asset (e.g. a pharmaceutical product), IP registration approval probability and timing, regulatory approval (e.g. U.S. Food and Drug Administration approval) probability and timing, product commercialization probability and timing, current and historical market information and precedent information of comparable assets are received by the computing devices and servers 202, which can be via user input, and/or retrieved from third party and/or public information source.

In one embodiment, the valuation is performed by value assessment execution logic residing in parts or in whole in the computing devices and servers 202 and may employ one or more machine learning techniques such as recurrent neural network based and convolutional neural network based deep learning techniques using historical market information and precedent information of comparable assets as training dataset for training one or more classifiers. The computing devices and servers 202 may be further configured to render a GUI for receiving the user input on the valuation method selection and the variable parameter values.

In accordance to one embodiment, the binding of the economic ownership of the backing asset to the cryptocurrency of choice of the Token Sale, or more precisely to the to-be-issued tokens 304 is accomplished by transferring to or creating the economic ownership in a cryptocurrency holding entity, which can be a holding company, partnership, or trust, corresponding to the determined economic value of the backing asset. The mechanism of the economic ownership transfer or creation may include the execution of a binding contract governing the economic interests, such as derived income and sales proceeds, in the backing asset being vested in the holding entity. In one embodiment, the binding contract may be implemented by legal instruments including fixed and floating charges. In another embodiment, the binding contract may be implemented by a blockchain-based smart contract or may be referenced in the smart contract. The smart contract may contain terms governing the nature of the economic interests, effective period, guarantees, and revocability, and/or the binding contract. In one embodiment, the one or more of the computing devices and servers 202 are further configured to render a GUI for displaying the terms and receiving user input including the user's identification and execution on the smart contract, and to add a new block to the smart contract blockchain.

In accordance to one embodiment, the token pricing function 305 is executed to set the cryptocurrency token price, wherein the pricing function takes as input the determined economic value, from the valuation of the economic value of the backing assets 303, of the backing asset, the cryptocurrency holding entity's economic ownership in the backing asset, and a selected quote currency. In one embodiment, the one or more of the computing devices and servers 202 are further configured to render a GUI for displaying the token and receiving user input on quote currency selection, and to execute the pricing function.

In the case where the ICO is for a brand-new cryptocurrency, the computing devices and servers 202 and databases 203 are configured to allocate computing and data storage resources and communicate with the nodes 204 with instructions to create, instantiate, and maintain a separate blockchain. The computing devices and servers 202 are further configured to initiate the ICO event by sending electronic messages (e.g. email, instant messages, etc.) to a list of subscriber computing devices notifying the offer start time and end time, token price, and subscription criteria; receiving, via data exchange communications from the subscriber computing devices, token subscription requests during the time period as specified by the offer start time and end time. At the end of the closing of the ICO offer time period, the computing devices and servers 202 determine if the fund-raising goal is met and compute the number of tokens to be created based on the subscription requests received. If the fund-raising goal is met, the computing devices and servers 202 effectuate the token creation and issuance by creating and adding to the blockchain of the cryptocurrency of the ICO the new blocks corresponding to the subscribed and issued tokens.

In accordance to another aspect of the present invention, the cryptocurrency platform provides a change process of handling changes in the composition of a cryptocurrency's backing assets and/or the legal ownerships in the backing assets. The change process comprises the computing devices and servers 202 receiving one or more change data including at least the identification of a backing asset and the change details information data; verifying the change data by matching the received and extracted identification in the databases with an existing record of a backing asset of issued cryptocurrency tokens; re-verifying the legal interest in the backing asset by analyzing the title documents provided in the change data, and relevant documents and records queried and retrieved from public information systems; re-executing the mechanism of binding the economic ownership of the backing asset to the cryptocurrency based on the composition information provided in the change data by re-executing a smart contract of vesting of economic interests in the backing assets of new composition in the corresponding cryptocurrency holding entity.

In one embodiment of the present invention using a cryptocurrency (hereinafter referred to as “Smart Pharma Token (SMPT)”) that specifically addresses the securing and holding by floating charges he economic ownerships of the backing assets in a holding entity, the SMPTs, including those allocated and not allocated, are collectively entitled to the net income of holding entity 104, which can be the SMPT issuer. The net income os derived from the intellectual property rights and royalty monetarization of the backing assets, which can be the vehicles or projects that are generating the intellectual property rights (hereinafter referred to as “Project IP”). Such beneficial interest of the SMPTs are secured by way of a floating charge against the Project IP and its associated royalty monetarization rights to guarantee that of income of the issuer are distributed to the SMPT holders, which makes the SMPT is a truly collateralized security. As the number and value of the intellectual property rights (e.g. pharmaceutical drug or medical treatment candidates) obtained from the Project IP (e.g. the Smart-ACT™ program) increases while the supply of its SMPTs remains flat, the underlying secured interest and value of asset backed by the SMPTs rises, thus increasing the inherent value of SMPTs.

To summarize, the SMPTs can be backed by the following:
1.) intellectual property rights obtained from drug candidates discovered;
2.) applicable royalties based on net sales of the licensed products using the intellectual property rights upon commercialization;
3.) a percentage of sub-licensing revenue received from the licensed intellectual property rights; and
4.) consideration for assignment of the intellectual property rights to third parties (subject to common asset valuation methods such as discounted cash flow analysis).

The electronic embodiments disclosed herein may be implemented using computing devices, computer processors, or electronic circuitries including but not limited to application specific integrated circuits (ASIC), field programmable gate arrays (FPGA), and other programmable logic devices configured or programmed according to the teachings of the present disclosure. Computer instructions or software codes running in the general purpose or specialized computing devices, computer processors, or programmable logic devices can readily be prepared by practitioners skilled in the software or electronic art based on the teachings of the present disclosure.

All or portions of the electronic embodiments may be executed in one or more general purpose or computing devices including server computers, personal computers, laptop computers, mobile computing devices such as smartphones and tablet computers.

The electronic embodiments include computer storage media having computer instructions or software codes stored therein which can be used to program computers or microprocessors to perform any of the processes of the present invention. The storage media can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Various embodiments of the present invention also may be implemented in distributed computing environments and/or Cloud computing environments, wherein the whole or portions of machine instructions are executed in distributed fashion by one or more processing devices interconnected by a communication network, such as an intranet, Wide Area Network (WAN), Local Area Network (LAN), the Internet, and other forms of data transmission medium.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

What is claimed is:

1. A method for electronically issuing and maintaining a cryptocurrency backed by one or more backing assets comprising one or more of intellectual properties and intangible assets, the method comprising:
receiving and preserving by one or more computing devices and servers and databases initial coin offering (ICO) preparation data, wherein the preparation data include at least the identity information of a fund-raising entity, fund-raising goal minimum and maximum monetary amounts, subscription criteria, and offer start time and end time;
receiving and preserving in the computing devices and servers and databases information data on the backing assets comprising identification data, descriptions, types, cost data, income data, and ownership data;
verifying the backing assets by comparing the backing asset identification data and ownership data to records queried and retrieved from public information systems;
valuating the backing assets' economic value of the backing asset based on one or more valuation methods with input variable parameter values comprising one or more of costs on research and development in generating the backing assets, costs on procuring and maintaining the backing assets, past license royalty received, future license royalty expected, allotted operating income based on the backing assets received, and future operating income based on the backing assets expected, projected market size and revenue generated from the use of the backing assets, the backing assets' registration approval probability and timing, the backing assets' regulatory approval probability and timing, commercialization probability and timing, current and historical market data and precedent data of comparable assets;
binding the backing asset's economic ownership to the cryptocurrency by effectuating an execution of a smart contract by the fund-raising entity vesting the backing asset's economic ownership in a cryptocurrency holding entity; and
executing a token pricing function to set the cryptocurrency token price, wherein the pricing function takes as input the backing assets' economic value, the cryptocurrency holding entity's economic ownership in the backing assets, and a selected quote currency.

2. The method of claim 1, further comprising:
notifying subscriber computing devices of the ICO offer start time and end time, the cryptocurrency token price, and the subscription criteria;
receiving from the subscriber computing devices token subscription requests; and
effectuating the cryptocurrency token creations, issuances, and subscriptions by creating and adding to the cryptocurrency blockchain one or more new blocks recording transactions of to the subscriptions.

3. The method of claim 1, further comprising:
changing the backing assets composition comprising:
receiving one or more change data including at least identification data, descriptions, types, cost data, income data, and ownership data of a backing asset to be added to or removed from the backing assets composition.

4. The method of claim 1, wherein the backing assets comprising one or more of registered patents, pending patent applications, registered and unregistered trademarks, registered and unregistered industrial design and design patents, copyrights, trade secrets, commercialization rights, know-hows, and discoveries.

5. The method of claim 1, wherein the backing assets comprising one or more of licenses to, liens on, options to purchase or sell, security interests in intellectual property rights.

6. A cryptocurrency infrastructure for issuing and maintaining a cryptocurrency backed by one or more backing assets comprising one or more of intellectual properties and intangible assets, the cryptocurrency infrastructure comprising:
a cryptocurrency platform having one or more computing devices and servers, and one or more databases configured to create and maintain a data schema for hosting one or more initial coin offerings (ICOs) and one or more exchanges; and
one or more node computing devices and servers each configured to preserve at least a portion of a distributed ledger of records of transactions on the cryptocurrency;
wherein the cryptocurrency platform is configured to:
receive and preserve the ICO preparation data, wherein the preparation data include at least the identity information of a fund-raising entity, fund-raising goal minimum and maximum monetary amounts, subscription criteria, and offer start time and end time;
receive and preserve information data on the backing assets comprising identification data, descriptions, types, cost data, income data, and ownership data;
verify the backing assets by comparing the backing asset identification data and ownership data to records queried and retrieved from public information systems;
valuate the backing assets' economic value based on one or more valuation methods with input variable parameter values comprising one or more of costs on research and development in generating the backing assets, costs on procuring and maintaining the backing assets, past license royalty received, future license royalty expected, allotted operating income based on the backing assets received, and future operating income based on the backing assets expected, projected market size and revenue generated from the use of the backing assets, the backing assets' registration approval probability and timing, the backing assets' regulatory approval probability and timing, commercialization probability and timing, current and historical market data and precedent data of comparable assets;
bind the backing asset's economic ownership to the cryptocurrency by effectuating an execution of a smart contract by the fund-raising entity vesting the backing asset's economic ownership in a cryptocurrency holding entity; and
execute a token pricing function to set the cryptocurrency token price, wherein the pricing function takes as input the backing assets' economic value, the cryptocurrency holding entity's economic ownership in the backing assets, and a selected quote currency.

7. The cryptocurrency infrastructure of claim 6, wherein the cryptocurrency platform is further configured to:
notify subscriber computing devices of the ICO offer start time and end time, the cryptocurrency token price, and the subscription criteria;
receive from the subscriber computing devices token subscription requests; and
effectuate the cryptocurrency token creations, issuances, and subscriptions by creating and adding to the cryptocurrency blockchain one or more new blocks recording transactions of to the subscriptions.

8. The cryptocurrency infrastructure of claim 6, wherein the cryptocurrency platform is further configured to:
change the backing assets composition comprising:
receiving one or more change data including at least identification data, descriptions, types, cost data, income data, and ownership data of a backing asset to be added to or removed from the backing assets composition.

9. The cryptocurrency infrastructure of claim 6, wherein the backing assets comprising one or more of registered patents, pending patent applications, registered and unregistered trademarks, registered and unregistered industrial design and design patents, copyrights, trade secrets, commercialization rights, know-hows, and discoveries.

10. The cryptocurrency infrastructure of claim 6, wherein the backing assets comprising one or more of licenses to, liens on, options to purchase or sell, security interests in intellectual property rights.
